(19) United States
(12) Patent Application Publication
(10) Pub. No.: US 2005/0193941 A1
(43) Pub. Date: Sep. 8, 2005

(54) Rescue signal device

(76) Inventor: Larry Schlasinger, Chetek, WI (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 10/793,312

(22) Filed: Mar. 4, 2004

(51) Int. Cl. G01D 21/00

(52) U.S. Cl. 116/209

(57) ABSTRACT

A rescue signal device for use in rescue or retrieval operations is disclosed. The rescue signal device is a polyhedral object including multiple reflective surfaces. The rescue signal device is generally spherical or hemispherical, with the multiple reflective surfaces providing it with numerous facets off of which light is reflected. Usually, the reflective surfaces will be mirrors. The rescue signal device may be buoyant enough to float on water, or if inflatable and a lighter than air gas is used, sufficiently buoyant to float in the air. The rescue signal device may be provided with a frame to increase its stability, and may be mounted on a pole or other support. If mounted upon an object, it is generally able to rotate such that it creates scintillating reflections as it moves. The rescue signal device may also include wind cups to encourage its rotation in the wind.

### FIELD OF THE INVENTION

This invention relates to a rescue signal device that uses reflected light to alert searchers or rescuers of the user's location.

### BACKGROUND OF INVENTION

Locating a lost or stranded person or group can be a difficult task, particularly in a marine environment. A single square mile includes approximately 28 million square feet, in which the several square feet occupied by a potential rescue can be extremely difficult to distinguish. This problem is particularly acute at sea, where thousands of square miles may need to be searched. Waves often higher than a man's head can obscure visibility, which may be further compounded by the sun's reflection off of the water. Search operations are frequently conducted by air, since this allows a large area to be viewed fairly quickly. However, the speed of the aircraft and the distance from the surface make spotting a small object such as lifeboat or an individual floating in the water extremely difficult. There is thus a great need for a rescue signal device capable of generating a highly visible signal to overcome these difficulties.

Similarly, locating a stranded or lost person or group on land can be difficult. While the search is generally confined to a smaller area, the person or group may be hidden among trees, camouflaged to match the environment, or otherwise obscured. Identifying a single figure or group of figures amongst the myriad of objects presented in an aerial view of land can thus be exceedingly difficult as well.

Currently, a variety of rescue signal devices are available. Among these are flares, dyes, and planar mirrors. While flares and dyes may be effective, they provide only an ephemeral signal which may easily occur at a time when no rescuers are nearby. Standard incendiary flares are most suitable for alerting rescuers at night, although colored smoke flares may be used during the day. In either case, the signal to rescuers is temporary, lasting only so long as the flare is burning or the smoke remains undispersed. Rescue dyes suffer from similar drawbacks. Rescue dyes generally derive their effectiveness from coloring the water surrounding those seeking rescue, creating a larger image that is more readily detected from a distance. Unfortunately, while dispersion of the dye is necessary to create a larger image, this dispersion continues until the dye is no longer distinguishable, at which point it becomes ineffective.

Planar mirrors are also useful as rescue signal devices. Typically, these mirrors are manipulated to reflect the sun outwards from the mirror in a single ray. While a reflected light signal has the advantage of maintaining a relatively constant signal, generating the reflection generally requires those seeking rescue to be fully conscious and able to skillfully manipulate the mirror to reflect the sunlight in a useful direction as the sun's position shifts or conditions change. Often those in need of rescue are injured or unconscious, making it difficult or impossible for them to operate a planar mirror. This operational burden, and the unidirectional nature of the reflected ray, significantly decrease the usefulness of planar mirrors as rescue signal devices.

Therefore, there remains a need for a rescue signal device that is capable of generating a lasting and highly visible rescue signal without requiring significant effort by those in need of rescue.

### SUMMARY OF INVENTION

A rescue signal device that generates a lasting and highly visible signal without requiring significant effort to operate is disclosed. In particular, the rescue signal device may be used by one or more individuals in need of rescue or retrieval located in water or on the ground to alert potential rescuers of their location. The rescue signal device is particularly useful for alerting rescuers searching from the air; for example, by plane or helicopter.

The rescue signal device comprises a generally spherical polyhedral body having a plurality of reflective planes on its surface. The numerous reflective surfaces enable the rescue signal device to generate a highly visible scintillating signal with minimal effort on the part of the user. A roughly spherical embodiment of the present invention could thus bear a very large number of small reflective panels. The number of panels present in a polyhedral body according to the present invention may be mathematically described as a top panel and a bottom panel, both having N panels, and X additional rings of panels extending from the top panel to the bottom panel, wherein the total number of panels can be determined by solving the equation NX+2. In addition to roughly spherical forms, the polyhedral body may be truncated to form a rough hemisphere, with a planar lower surface. This is particularly desirable when the lower portion, or base, of the rescue signal device is not expected to be visible, or if the rescue signal device is likely to be placed directly on the ground. In these cases, it is typically unnecessary to make this lower surface reflective.

The rescue signal device may be constructed such that it is buoyant in water. In alternate embodiments, the buoyancy of the rescue signal device may be sufficient to allow it to act as a flotation device. To further increase buoyancy, the rescue signal device may be inflated using air, helium, or another gas. The rescue signal device may be tethered to the ground or an object such as the person needing rescuing, via a strong cord. This is particularly desirable if a highly buoyant gas such as helium is used to inflate the rescue signal device.

The rescue signal device may be adapted to be mounted to a pole or other suitable support such as a boat, lifejacket or raft. Mounting to a pole has the advantage of elevating the rescue signal device, and provides an axis around which the rescue signal device can rotate. In any of these various mounting configurations, springs may be used to increase the flexibility and motion of the rescue signal device. As a general matter, movement of the rescue signal device will increase the number of directions in which light from the rescue signal device is reflected, as well as creating a more scintillating signal. This, in turn, makes the signal more noticeable, increasing the likelihood of attracting potential rescuers.

In an alternative embodiment, additional components may be attached to the rescue signal device to facilitate its motion and/or to increase its visibility. The wind is a source of motion that is generally readily available. To take advantage of this, wind cups may be attached to the perimeter or other surfaces of the rescue signal device. The wind cups function to catch and trap air, causing the rescue signal device to spin or move about the pole or other apparatus on which it is mounted. In one embodiment, the wind cups are cups that may be attached to the rescue signal device in any suitable orientation and manner so as to enable them to catch the wind and impart motion. Flashlights or other luminary devices may also be attached to the rescue signal device at various points where they illuminate one or more reflector components, in order to increase the usefulness of the device during night or during heavy overcast.

### BRIEF DESCRIPTION OF THE DRAWINGS

FIG. 1 is a perspective view of an octagonal-patterned polyhedral body with twenty six panels for use as a rescue signal device.

FIG. 2 is a bottom view of an octagonal-patterned polyhedral body with twenty six panels for use as a rescue signal device.

FIG. 3 is a perspective view of a hemispheric version of an octagonal-patterned rescue signal device.

FIG. 4 is a side view of a hemispheric version of a hexagonal-patterned rescue signal device.

FIG. 5 is a perspective view of a hemispheric version of the hexagonal-patterned rescue signal device.

FIG. 6 is a side view of an inflatable rescue signal device including an octagonal-patterned polyhedral body provided with a tether.

FIG. 7 is a side view of an attachment fixture used to secure the rescue signal device.

FIG. 8 is a bottom perspective view of an inflatable octagonal-patterned rescue signal device including an attachment fixture.

FIG. 9 is a perspective view of a rescue signal device attached to a pole with an attached flotation device.

FIG. 10 is a top view of a hexagonal-patterned rescue signal device with wind cups.

FIG. 11 is a perspective view of a hexagonal-patterned rescue signal device with wind cups mounted on a pole.

FIG. 12 is a front view of a hemispheric wind cup attached to a section of the frame of the rescue signal device.

FIG. 13 is a side view of an embodiment of the rescue signal device provided with a flexible pole.

FIG. 14 is a cross-section view of a pole holder.

### DETAILED DESCRIPTION OF THE PREFERRED EMBODIMENTS

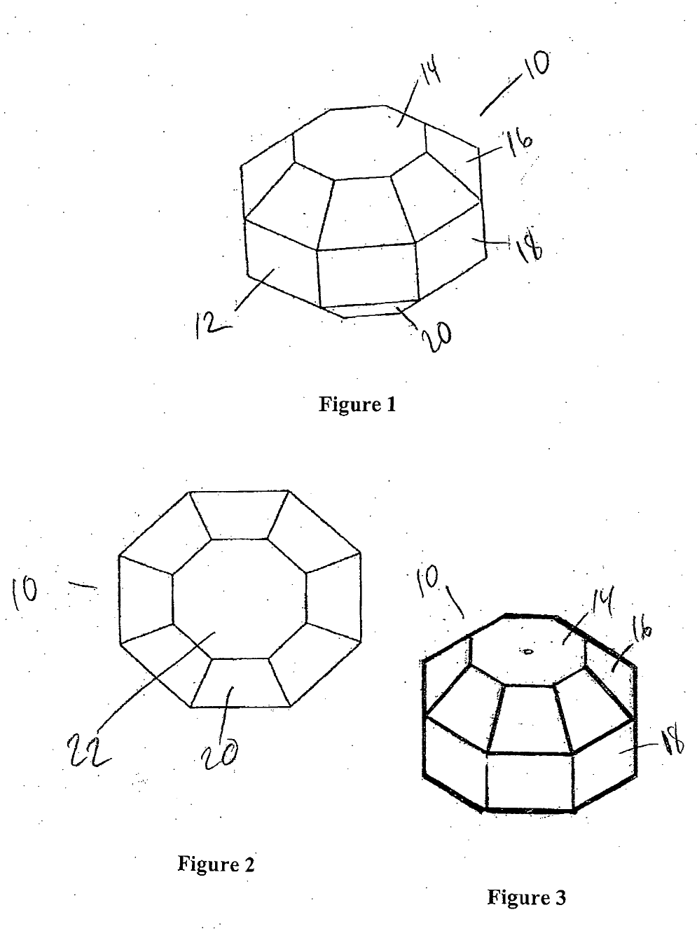

The rescue signal device 10 of the present invention comprises a polyhedral body 12 bearing a plurality of reflective surfaces. The rescue signal device 10 may be mathematically described as a polyhedral body with a top panel and a bottom panel, both having N panels, and X additional rings of panels extending from the top panel to the bottom panel, wherein the total number of panels can be determined by solving the equation NX+2. One embodiment of the present invention is shown in FIG. 1. In this embodiment, a rescue signal device 10 in which the top and bottom panels are octagons (N=8) and three additional rings of panels (X=3) are present, provides a twenty six-sided polyhedral body 12 as shown in FIG. 1. One or more of the panels are reflective panels, and it is generally preferred that they are all reflective. The polyhedral body 12 is divided into several regions; the top panel 14, the upper sloped panels 16, the perimeter panels 18, lower sloped panels 20, and a bottom panel 22 (not visible). In this particular embodiment, the reflective panels making up the top panel 14 and the bottom panel 22 are octagonal, the remaining perimeter panels 18 are rectangular, while the upper sloped panels 16 and the lower sloped panels 20 are trapezoids. This particular embodiment of the present invention is shown in a bottom view in FIG. 2, which shows the octagonal bottom panel 22 and the trapezoidal reflective surfaces making up the lower sloped panels 20.

FIG. 3 illustrates a rescue signal device 10 based on the octagonal design shown in FIGS. 1 and 2, but truncated to remove the lower sloped panels 20, creating a roughly hemispheric shape. A rescue signal device 10 with a proportionally larger bottom panel 22 is able to rest more securely on the ground, without rolling, and may also be preferred if the polyhedral body is mounted on a pole or other device such that the lower reflective surfaces are unlikely to see use. The bottom panel 22 of this embodiment of the rescue signal device 10 is a much larger octagon in shape, and generally need not be reflective, though it may be. The remaining top panel 14, upper sloped panels 16, and perimeter panels 18 are the same as shown in FIG. 1, and should be reflective.

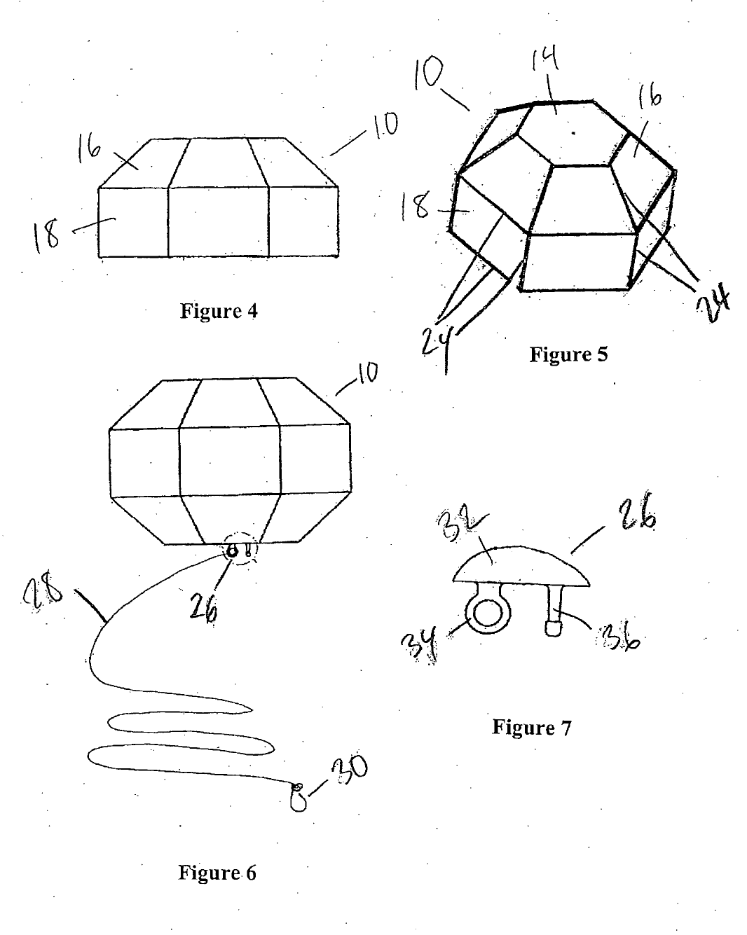

The generally hemispheric shape is more clearly shown in the panel view provided in FIG. 4 of a hexagonal-patterned rescue signal device. A hexagonal-patterned rescue signal device has a top panel 14 and a bottom panel 22 that are hexagonal (N=6), but is otherwise similar in overall design to the octagonal-patterned rescue signal device shown in FIG. 1. The hemispheric hexagonal-patterned rescue signal device 10 also has upper sloped panels 16 that are trapezoids and perimeter panels 18 that are rectangular. Hexagonal-patterned rescue signal devices following this design will generally have fewer panels than an octagonal-patterned rescue signal device, as each of the rings between the top and bottom panel will only have six panels rather than eight. The full hexagonal-patterned rescue signal device with three rings (X=3) will be an icosahedron with 20 panels, while the truncated, hemispheric version (where X=2) will have only 14 panels. A perspective view of a hemispheric version of the hexagonal-patterned rescue signal device is shown in FIG. 5.

It should also be apparent to one of skill in the art that while the embodiments shown teach the use of a whole or hemispheric octagonal or hexagonal-patterned polyhedron, a wide variety of polyhedrons may be used, so long as they provide a plurality of panels that may be used as reflective surfaces. For example, at the lower end, a pyramid shape may be used, in which case there may be only 4 panels. Alternately, the polyhedron may have so many panels—up to 500 or more—that it resembles a many-faceted “disco ball.” While in some embodiments all of the panels may be reflective, in other embodiments it may only be necessary or advantageous to make some of the panels reflective. The size of the rescue signal device 10 may range from about 6″ to about 25′.

The rescue signal device 10 is made in a polyhedral shape and is covered on its outer surface with reflective components. Preferably, the reflective components are mirrors. The reflective components may conform exactly to the shape of the polyhedral body, or more specifically, the particular panel of the polyhedral body where they are placed. Alternately, or in addition, reflective components having slightly offset angular orientations relative to one another and/or the polyhedral body may be included.

The rescue signal device 10 has an outer surface that is covered with a plurality of reflectors, preferably mirrors. These may be fixed to the surface of the rescue signal device 10, or the surface of the rescue signal device 10 itself may be a reflective material. While the reflectors used on the rescue signal device 10 will generally be referred to as mirrors, any suitable reflector components may be used. For example, metal foils, polished metal, and various reflective polymeric materials such as those used in reflective tape may also be used. The outer surface 12 may be covered entirely or in part by mirrors. The mirrors may individually conform to the panels present on the top panel 14, the upper sloped panels 16, the perimeter panels 18, lower sloped panels 20, and, optionally, the bottom panel 22. Alternatively, several smaller mirrors having slightly offset angular orientations to one another may be positioned on each of these panels.

The rescue signal device 10 may be made of plastic, metal, polystyrene, or other suitable material. Lightweight materials are preferred, as they render the device more easily transportable, and may contribute to its buoyancy. These lightweight materials are molded to form the a polyhedral shape. The rescue signal device 10 will generally be hollow and have an inner surface in addition to an outer surface. However, the properties of the inner surface are relatively unimportant, and the rescue signal device 10 may be constructed from a solid piece of lightweight material such as polystyrene foam, in which case it may not have an inner surface. Of course, if the rescue signal device 10 is designed to be inflatable, it will likely have a hollow space within, and should generally be flexible.

The rescue signal device 10 may include a frame 24 to provide additional support for the polyhedral body. The outer frame may extend to each corner and along the edges of the panels, and helps maintain each of the panels in proper orientation to one another. The frame 24 is preferably made of wire, steel or other suitable thin, high-strength material. The frame may either be positioned within the polyhedral body, or along its outside surface. While the frame will generally be rigid, it is also possible to utilize a flexible frame such as one in which various short metal wires are connected in each corner through moveable, intertwined wire loops. A flexible frame of this design provides support and attachment points for mirrors, but can still collapse to occupy a minimal amount of space.

The rescue signal device 10 may be constructed such that it is buoyant in water. This may be accomplished by using lightweight materials such as polystyrene foam, constructing the rescue signal device 10 so that it contains large air pockets, or through other means known to those skilled in the art. In some embodiments, the buoyancy of the rescue signal device may be sufficient to allow it to act as a flotation device. The rescue signal device 10 may also be designed so that it can be inflated using air, helium, or another gas. For embodiments of this nature, the rescue signal device 10 may be both inflatable and collapsible, and is preferably made of a thin and flexible plastic or airtight fabric to accommodate this aspect. Mylar, rubber, plastic, or PVC may be used for an inflatable rescue signal device 10, for example, and should be puncture resistant. In an inflatable embodiment, the rescue signal device may be provided with a valve stem to enable inflation by a pump.

The rescue signal device 10 may be provided with an attachment fixture to allow it to be tethered to the ground or an object, such as the person needing rescue, by a strong cord. This embodiment is shown in FIG. 6, which shows an octagonal-patterned rescue signal device 10 provided with an attachment fixture 26 and a cord 28. The cord 28 is preferably tied or otherwise attached to the attachment fixture 26 at one end, while the other end of the cord 28 is either tied or attached with a clip 30 or other attachment device to a secure object. Attachment to a secure object is particularly desirable if a highly buoyant gas such as helium is used to inflate the rescue signal device 10, as the rescue signal device 10 will be ineffective if allowed to drift away from those in need of rescue. Attachment of a cord 28 to the rescue signal device 10 allows the device to be released and, if inflated with a gas lighter than air, such as helium, to float in the air to increase visibility. The cord 28 may also be used to support a flag, streamer, strobe light, or other component to increase visibility of the rescue signal device 10.

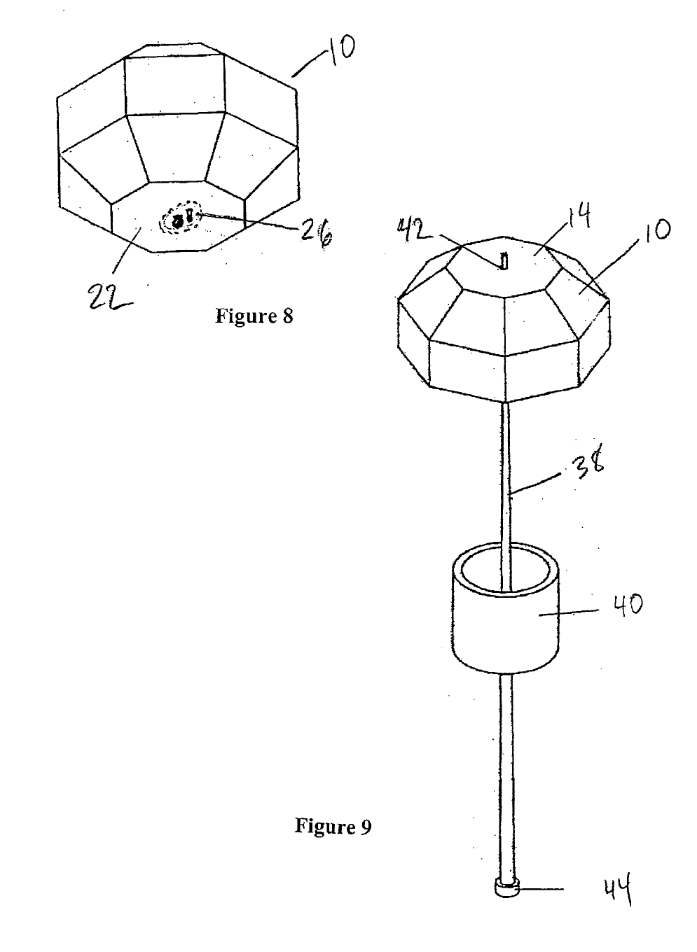

The attachment fixture 26 is shown in more detail in FIG. 7. The attachment fixture comprises an anchor 32 used to secure the attachment fixture 26 to the rescue signal device 10 and an attachment point 34, which may be a ring, for example. The attachment point 34 may be provided with a ball-in-socket connection to the attachment fixture 26 (not shown) or similar rotatable connection if it is the rescue signal device 10 is likely to rotate, as this will help prevent the attached cord 28 from getting tangled. The attachment fixture 26 may also be provided with a valve stem 36 if the rescue signal device 10 is inflatable, to enable gas to be easily pumped into the rescue signal device 10. The attachment fixture 26 is preferably mounted to the bottom panel 22 of the rescue signal device 10, as shown in FIG. 8. A detachable canister of compressed helium or other gas may be provided with inflatable embodiments of the rescue signal device 10 that can be used to rapidly inflate the rescue signal device 10 when necessary.

FIG. 9 displays an embodiment of the rescue signal device 10 attached to a pole 38 having a flotation device 40 attached to the pole 38. The pole 38 may be attached to the rescue signal device 10 by inserting the top of the pole 38 into a hole 42 present in the top panel 14 of the rescue signal device 10. The flotation device 40 provides additional buoyancy for the attached rescue signal device 10; preferably more than enough to offset the additional weight of the pole 38. In an additional embodiment of this aspect of the invention, the additional buoyancy provided may be sufficient to hold the rescue signal device 10 above the waterline, such that it can sway with the motion of the waves. For this embodiment, it is preferable to place the flotation device 40 near the middle of the pole 38. The increased height and motion of the rescue signal device 10 will increase its capacity to alert potential rescuers. It may also be desirable to attach a weight 44 to the bottom end of the pole 38. The weight 44 functions to keep the center of gravity of the apparatus below the waterline to prevent flipping and remain in an upright position while floating in the water.

The rescue signal device 10 may be adapted to be mounted to a pole 38 as described, or other suitable support such as a boat, lifejacket or raft. If the rescue signal device 10 is mounted to a pole 38, various types of poles, including but not limited to man overboard poles, retractable poles, and poles containing springs may be used. Man overboard poles are particularly suitable when using the rescue signal device at sea. Retractable poles, on the other hand, are useful for extending the device above a canopy of trees to increase aerial visibility.

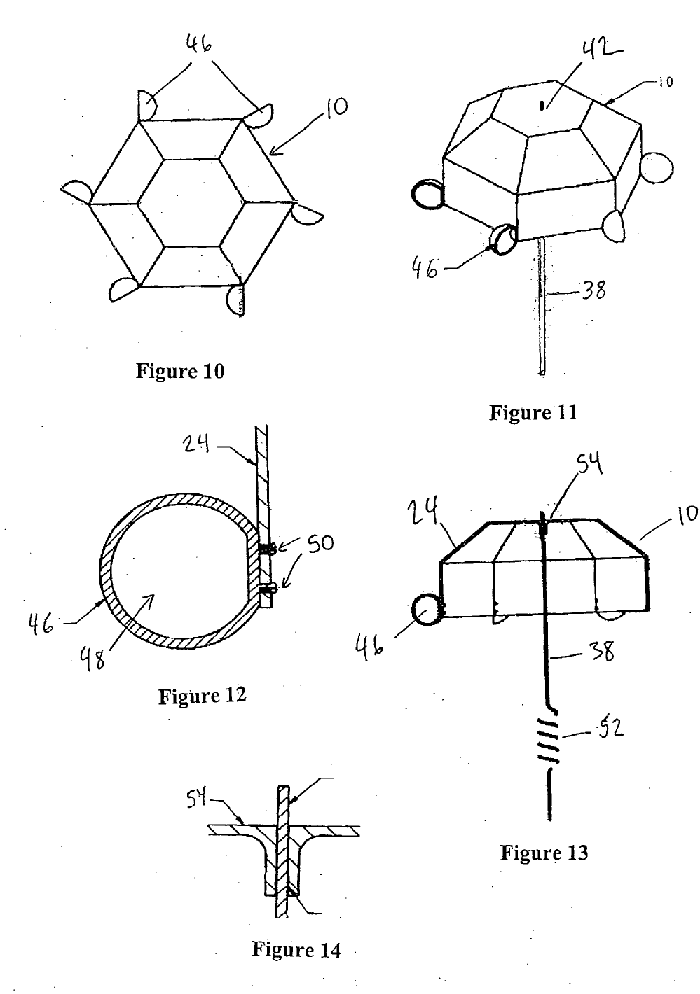

FIGS. 10 and 11 present an embodiment of the invention in which wind cups 46 are attached to corners along the perimeter panels 18 of a hexagonal-patterned rescue signal device 10. FIG. 10 provides a top view of an embodiment of the invention using wind cups 46, while FIG. 11 provides a perspective view of an embodiment of the invention with wind cups 46 in which the rescue signal device is mounted on a pole 38. It is particularly desirable to mount the rescue signal device 10 to a pole 38 when wind cups 46 are used to enable free rotation of the rescue signal device 10. The term “wind cup” as used herein is intended to encompass other devices that would serve to convert motion of the wind to motion of the rescue signal device 10, such as simple vanes, open boxes, or other shapes.

While it is preferable to have a wind cup 46 at each corner around the perimeter of the polyhedral body 12, as few as a single wind cup 46 will suffice to impart motion. While positioning of the wind cups 46 on the corners is preferred, wind cups 46 may be attached at various other points about the perimeter of the rescue signal device 10 or other locations on the surface of the rescue signal device 10. The wind cups 34 should be oriented towards either the left or the right (but not both) along the perimeter of the rescue signal device 10. Wind cups 46 arrayed in this fashion are able to work cooperatively to impart motion to the rescue signal device 10 when subjected to wind. For example, in FIG. 10, all of the wind cups 46 open to the left.

FIG. 12 displays a close up view of a preferred wind cup 46. The wind cup 46 is preferably formed as a cup having an inner concavity 48, and is similar overall to those used in wind anemometers. The inner concavity 48 functions to catch air blowing in its direction. Wind motion is thus transferred to the wind cup 46 which in turn causes the rescue signal device 10 to rotate about a support such as a pole 38. The wind cup 46 is shown attached to the frame 24 by two pegs 50. Various other attachment means may be used other than pegs 50; for example, staples, clips, screws, etc. may all be utilized. As noted above, the wind cups 46 are preferably positioned at each corner formed by the intersection of the perimeter panels 18 of the rescue signal device 10.

It will be apparent to one of skill in the art that while wind cups 46 are described, a variety of other devices for catching wind or otherwise imparting rotation to the rescue signal device 10 may be used and are contemplated within the scope of the present invention. Rotating the rescue signal device 10 increases the effectiveness of the device by increasing the number of directions in which reflections are sent, as well as creating a scintillation effect that is more likely to catch the eye.

FIG. 13 displays an embodiment of the invention in which a rescue signal device 10 is mounted atop a pole 38 that is flexible. This may be accomplished by constructing the pole 38 of material with sufficient elasticity to allow bending along its length, or may be accomplished through inclusion of a spring 52 to replace a portion of the length of the pole 38, as shown in FIG. 13. Use of a flexible pole 38 provides the advantage of increasing the likelihood that the rescue signal device 10 will sway, thereby increasing its visibility, and introduces an element of convenience by enabling the pole 38 to be bent.

As shown in FIG. 13, the pole may be attached to the rescue signal device 10 by extending the top of the pole 38 through the opening 42 in the top panel 14 of the rescue signal device 10. The opening 42 may be reinforced by providing it with a pole holder 54. FIG. 14 displays a pole holder 54 attached to top panel 14 of the rescue signal device 10 aligned with opening 42. The pole holder 54 is preferably made of steel and is configured to receive pole 38 and secure its attachment to the rescue signal device 10. For embodiments in which it is desired that the polyhedral body 12 rotate around the pole 38, bearings or similar mechanical devices known to those skilled in the art should be used within the pole holder 54. The pole 38 may be further secured using a lock pin or other device to prevent the pole 38 from withdrawing from the opening 42 and the pole holder 54. Alternatively, the tip of the pole 38 may be threaded as a screw to enable a wing nut or similar device to secure the rescue signal device 10 to the pole 38.

Details of the use of the rescue signal device 10 will vary depending on the conditions in which those in need of rescue find themselves, as well as the particular embodiment of the rescue signal device 10 being used. The steps involved in use of the present invention are few, as the simplicity of use of the present invention is one of its advantages. However, as lighter-than-air inflatable embodiments are a preferred form of the invention, use of this embodiment of the invention will be described. When a situation arises in which rescue or retrieval is needed, the user can retrieve the rescue signal device 10 and inflate it from its collapsed state, preferably using a detachable canister of compressed helium or other gas, by attaching a line to the valve stem 36 and then filling the rescue signal device 10 with lighter-than-air gas. If not already secured, the rescue signal device 10 should be secured to an object to prevent its drifting before inflation. Once inflated, the rescue signal device 10 will rise above those in need of rescue to the extent allowed by the cord 28, where it will sway in the wind, generating a multitude of reflections as light is reflected off of the numerous reflective surfaces positioned on its various panels. As there are multiple reflective planes presented by its polyhedral surface, and these are constantly shifting orientation as the rescue signal device moves, precise alignment with the sun is not necessary and signals are sent in many directions in a sparkling fashion likely to catch the eye of any within visual range of the device. The rescue signal device 10 will continue to operate in this fashion as long as necessary, without human intervention.

The rescue signal device 10 may also be provided as ready-to-use kit. The kit should provide all of the components necessary to use the rescue signal device 10, and should be compact enough to allow convenient storage. Use of a kit is particularly useful for inflatable embodiments of the invention, which can be quite compact before inflation. A kit of an inflatable embodiment would generally include an inflatable, reflective polyhedral body 12 with an anchor 32, a cord 28, and a canister of lighter-than-air gas that can be used to quickly inflate the reflective polyhedral body when rescue or retrieval is needed.

The various embodiments of the present invention thus provide a highly visible rescue signal device 10 with which a stranded or lost person can generate a lasting and highly visible signal indicating his or her location to potential rescuers without requiring significant effort to operate.

While particular embodiments in accordance with the present invention have been shown and described, it is understood that the invention is not limited thereto, and is susceptible to numerous changes and modifications as would be obvious to those skilled in the art. Therefore, the invention is not limited to the details shown and described herein, and includes all such changes and modifications as encompassed by the scope of the appended claims.

1. A rescue signal device comprising a polyhedral body comprising a top panel and a bottom panel, both having N panels, and X additional rings of panels extending from the top panel to the bottom panel, wherein the total number of panels can be determined by solving the equation NX+2 and one or more of the panels are reflective panels.

2. The rescue signal device of claim 1, wherein the reflective panels comprise mirrors.

3. The rescue signal device of claim 1, wherein the top panel and the bottom panel are hexagons such that N=6.

4. The rescue signal device of claim 1, wherein the top panel and the bottom panel are octagons such that N=8.

5. The rescue signal device of claim 1, further comprising a frame contiguous with the edges of the polyhedral body.

6. The rescue signal device of claim 1, wherein the rescue signal device is buoyant in water.

7. The rescue signal device of claim 1, wherein the rescue signal device is inflatable.

8. The rescue signal device of claim 7, wherein the inflated rescue signal device is lighter than air.

9. The rescue signal device of claim 1, wherein one end of a pole is attached to the polyhedral body.

10. The rescue signal device of claim 9, wherein the pole contains a flexible region.

11. The rescue signal device of claim 10, wherein the flexible region is a spring.

12. The rescue signal device of claim 9, wherein a flotation device is attached to the pole.

13. The rescue signal device of claim 12, wherein a weight is attached near the end of a pole opposite the end to which the polyhedral body is attached.

14. The rescue signal device of claim 1, wherein a flexible cord is attached to the polyhedral body.

15. The rescue signal device of claim 1, one or more wind cup is attached to the polyhedral body.

16. A rescue signal device comprising:
a polyhedral body with a plurality of panels, wherein one or more of the panels comprise reflective panels;
a pole attached at one end to the polyhedral body; and
one or more wind cups attached to the polyhedral body;
wherein the wind cups are configured to rotate the polyhedral body around the pole when it is placed in a wind.

17. The rescue signal device of claim 16, wherein the polyhedral body comprises a top panel and a bottom panel, both having N panels, and X additional rings of panels extending from the top panel to the bottom panel, wherein the total number of panels can be determined by solving the equation NX+2.

18. The rescue signal device of claim 16, wherein the pole is a flexible pole.

19. A rescue signal device comprising:
a polyhedral body with a plurality of panels, wherein one or more of the panels comprise reflective panels;
the polyhedral body is inflatable, and
a flexible cord is attached to the polyhedral body,
wherein the inflated polyhedral body is lighter than air and will float upwards in air to the extent allowed by the length of the flexible cord.

20. The rescue signal device of claim 19, wherein the rescue signal device is provided in a compact kit that further comprises a canister of compressed lighter-than-air gas.
